(19) United States
(12) Patent Application Publication
(10) Pub. No.: US 2024/0091986 A1
(43) Pub. Date: Mar. 21, 2024

(54) CUTTING TOOL HOLDING DEVICE

(71) Applicant: EVERPADS CO., LTD., Taichung (TW)

(72) Inventor: Chun-Li CHIANG, Taichung (TW)

(21) Appl. No.: 18/242,905

(22) Filed: Sep. 6, 2023

(30) Foreign Application Priority Data
Sep. 15, 2022 (TW) 111210049
Sep. 15, 2022 (TW) 111210055
Sep. 15, 2022 (TW) 111210057

(51) Int. Cl. B28D 1/18

(52) U.S. Cl. CPC B28D 1/186

(57) ABSTRACT

A cutting tool holding device includes a base and a holder. The base includes a base body and an inserted bore. The base body includes a central connecting surface and two positioning surfaces. A lateral edge of each of the positioning surfaces is connected to the central connecting surface, and the two lateral edges are defined as a first lateral edge pair. The holder includes a disposing head and a shaft. The disposing head includes a head body and a tool bore. The head body includes a disposing surface and two bearing surfaces. Two lateral edges of the two bearing surfaces are defined as a second lateral edge pair. Two extending lines of the two lateral edges of at least one of the first lateral edge pair and the second lateral edge pair are close to each other.

### RELATED APPLICATIONS

This application claims priority to Taiwan Application Serial Number 111210049, filed Sep. 15, 2022, Taiwan Application Serial Number 111210055, filed Sep. 15, 2022, and Taiwan Application Serial Number 111210057, filed Sep. 15, 2022, which are herein incorporated by reference.

### BACKGROUND

### Technical Field

The present disclosure relates to a cutting tool holding device. More particularly, the present disclosure relates to a cutting tool holding device for a milling machine.

### Description of Related Art

A milling drum of a road milling machine may employee a plurality of cutting tools, and the cutting tools are arranged helically. As the road milling machine walks, the milling drum rotates to drive the cutting tools to exert the milling job. The cutting tool is disposed at the milling drum via a cutting tool holding device.

A conventional cutting tool holding device includes a base and a holder, and the holder is configured for the cutting tool to assemble thereto and is disposed at the base. The holder is detachably assembled with the base via a screwing member, and therefore the cutting tool may be repaired or changed.

The cutting tool is used to mill the asphalt road, and the cutting tool is easily broken owing to the reaction generated from the high pressure on the road exerted by the cutting tool. If the structure of the cutting tool holding device is not strong enough, assembling instability between the base and the holder may occur, and shocks generated by the reaction may damage the cutting tool holding device. As a result, the life time of the cutting tool holding device is reduced, and the cost of repair and replacement thereof is increased.

Based on the aforementioned problems, how to efficiently improve the structure of the cutting tool holding device becomes a target that those in the filed pursue.

### SUMMARY

According to one aspect of the present disclosure, a cutting tool holding device is applied for holding a cutting tool and includes a base and a holder. The base includes a base body and an inserted bore penetrating the base body. The base body includes a central connecting surface, and two positioning surfaces respectively located at two sides of the central connecting surface. The positioning surfaces are relatively inclined to define a positioning space. A lateral edge of each of the positioning surfaces is connected to the central connecting surface, and the two lateral edges are defined as a first lateral edge pair. The holder inserts the inserted bore and is configured for the cutting tool to insert thereinto. The holder includes a disposing head and a shaft. The disposing head includes a head body and a tool bore. The head body has a working side and a connecting side and includes a tool bore surface, a disposing surface and two bearing surfaces located at the connecting side. The tool bore surface is located above the disposing surface. Two lateral edges of the two bearing surfaces are respectively connected to two sides of the disposing surface, and the two bearing surfaces respectively correspond to the two positioning surfaces. Two side edges of the two bearing surfaces are respectively connected to two sides of the tool bore surface, and the lateral edge of each of the bearing surfaces is longer than the side edge of each of the bearing surfaces. The two lateral edges of the two bearing surfaces are defined as a second lateral edge pair. The tool bore penetrates the head body from the working side to the connecting side to form an opening on the tool bore surface, and the tool bore is configured for receiving the cutting tool. The shaft is connected to the disposing surface of the head body and configured for inserting the base. Two extending lines of the two lateral edges of at least one of the first lateral edge pair and the second lateral edge pair are close to each other.

### BRIEF DESCRIPTION OF THE DRAWINGS

The disclosure can be more fully understood by reading the following detailed description of the embodiments, with reference made to the accompanying drawings as follows:

FIG. 1 shows a cross-sectional view of a cutting tool holding device according to one embodiment of the present disclosure in an assembled state.

FIG. 2 shows a cross-sectional view of the cutting tool holding device of the embodiment of FIG. 1 in a separated state.

FIG. 3 shows one three-dimensional schematic view of a base of the embodiment of FIG. 1.

FIG. 4 shows another three-dimensional schematic view of the base of the embodiment of FIG. 1.

FIG. 5 shows a cross-sectional view of the base of the embodiment of FIG. 2 taken along line 5-5.

FIG. 6 shows a front view of the base of the embodiment of FIG. 1.

FIG. 7 shows a three-dimensional schematic view of a holder of the cutting tool holding device of the embodiment of FIG. 1.

FIG. 8 shows a side view of the holder of the embodiment of FIG. 1.

FIG. 9 shows a top view of the holder of the embodiment of FIG. 1.

FIG. 10 shows a back view of the holder of the embodiment of FIG. 1.

FIG. 11 shows a cross-sectional view of a cutting tool holding device according to another embodiment of the present disclosure in a separated state.

FIG. 12 shows a three-dimensional schematic view of a holder of the cutting tool holding device of the embodiment in FIG. 11.

FIG. 13 shows a back view of the holder of the embodiment of FIG. 11.

### DETAILED DESCRIPTION

The embodiments of the present disclosure will be illustrated with drawings hereinafter. In order to clearly describe the content, many practical details will be mentioned with the description hereinafter. However, it will be understood by the reader that the practical details will not limit the present disclosure. In other words, in some embodiment of the present disclosure, the practical details are not necessary. Additionally, in order to simplify the drawings, some conventional structures and elements will be illustrated in the drawings in a simple way; the repeated elements may be labeled by the same or similar reference numerals.

In addition, the terms first, second, third, etc. are used herein to describe various elements or components, these elements or components should not be limited by these terms. Consequently, a first element or component discussed below could be termed a second element or component. Moreover, the combinations of the elements, the components, the mechanisms and the modules are not well-known, ordinary or conventional combinations, and whether the combinations can be easily completed by the one skilled in the art cannot be judged based on whether the elements, the components, the mechanisms or the module themselves are well-known, ordinary or conventional.

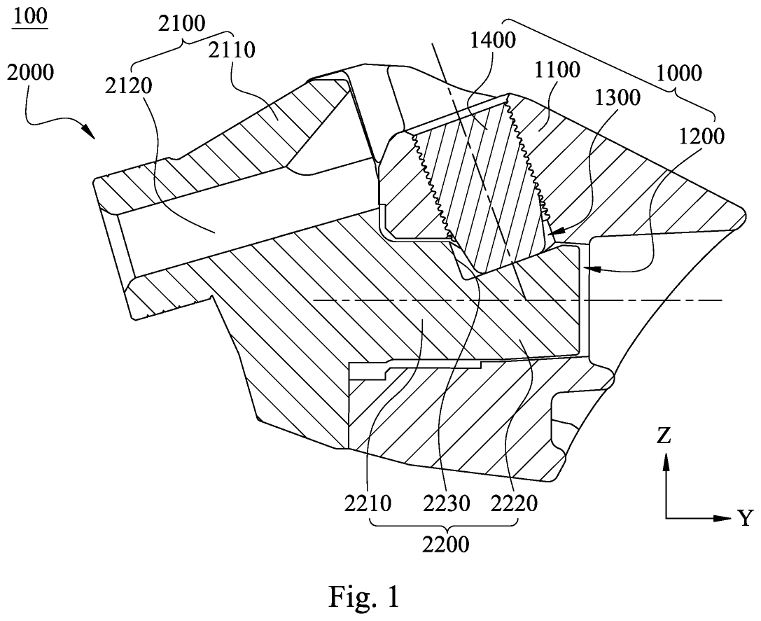

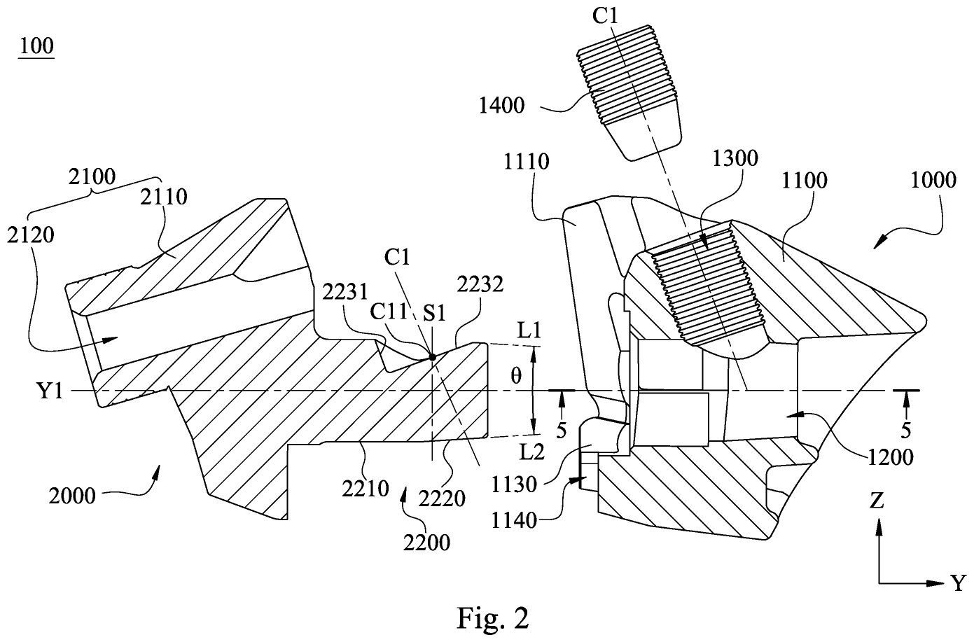

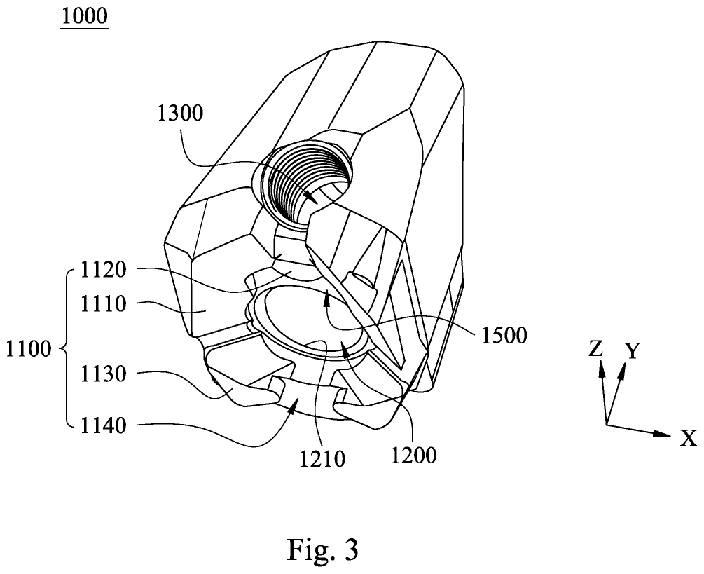

FIG. 1 shows a cross-sectional view of a cutting tool holding device 100 according to one embodiment of the present disclosure in an assembled state. FIG. 2 shows a cross-sectional view of the cutting tool holding device 100 of the embodiment of FIG. 1 in a separated state. FIG. 3 shows one three-dimensional schematic view of a base 1000 of the embodiment of FIG. 1. The cutting tool holding device 100 is applied for holding a cutting tool and includes a base 1000 and a holder 2000.

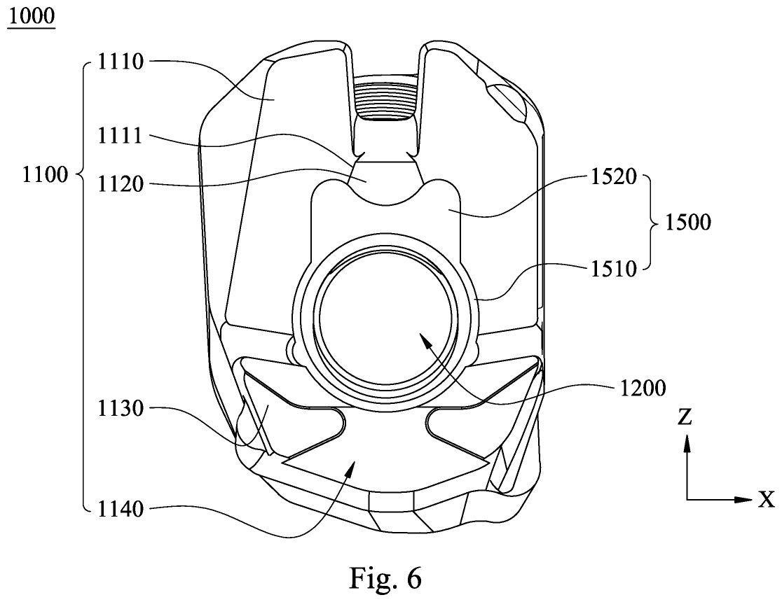

The base 1000 includes a base body 1100 and an inserted bore 1200 penetrating the base body 1100. The base body 1100 includes a central connecting surface 1120 and two positioning surfaces 1110 respectively located at two sides of the central connecting surface 1120. The positioning surfaces 1110 are relatively inclined to define a positioning space. A lateral edge 1111 (labeled in FIG. 6) of each of the positioning surfaces 1110 is connected to the central connecting surface 1120, and the two lateral edges 1111 are defined as a first lateral edge pair.

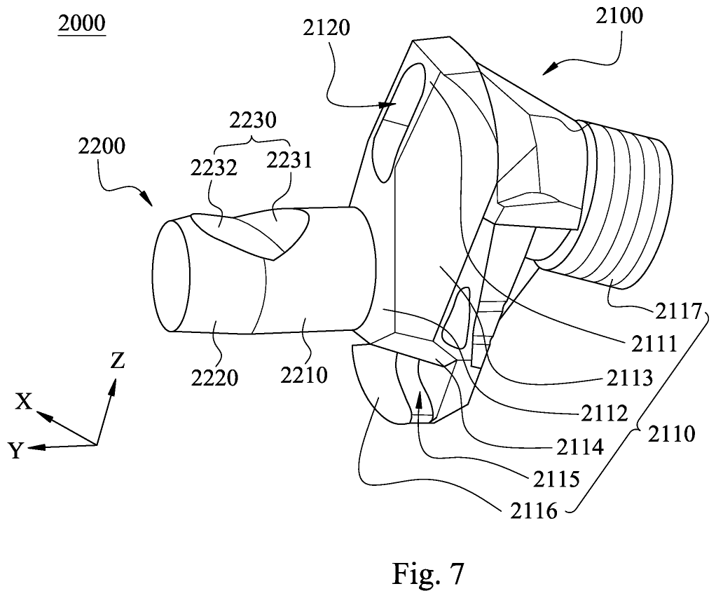

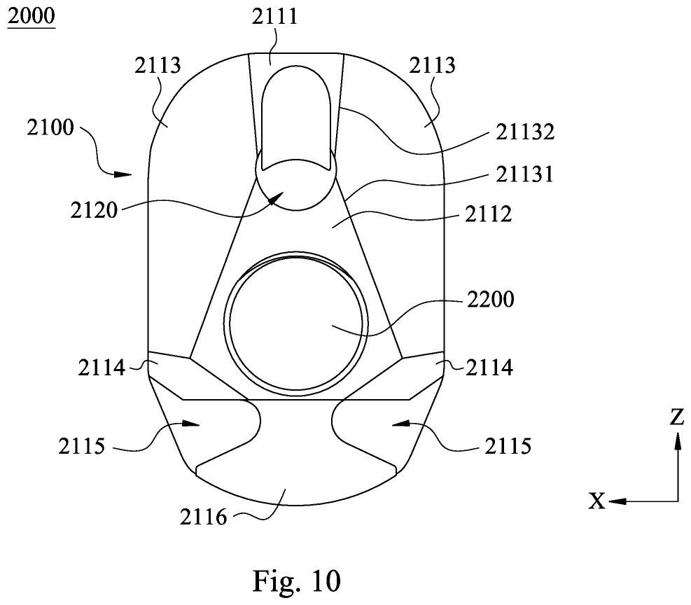

The holder 2000 inserts the inserted bore 1200 and is configured for the cutting tool to insert thereinto. The holder 2000 includes a disposing head 2100 and a shaft 2200. The disposing head 2100 includes a head body 2110 and a tool bore 2120. The head body 2110 has a working side and a connecting side and includes a tool bore surface 2111 (labeled in FIG. 7), a disposing surface 2112 (labeled in FIG. 7) and two bearing surfaces 2113 (labeled in FIG. 7) located at the connecting side. The tool bore surface 2111 is located above the disposing surface 2112. Two lateral edges 21131 (labeled in FIG. 10) of the two bearing surfaces 2113 are respectively connected to two sides of the disposing surface 2112, and the two bearing surfaces 2113 respectively correspond to the two positioning surfaces 1110. Two side edges 21132 (labeled in FIG. 10) of the two bearing surfaces 2113 are respectively connected to two sides of the tool bore surface 2111, and the lateral edge 21131 of each of the bearing surfaces 2113 is longer than the side edge 21132 of each of the bearing surfaces 2113. The two lateral edges 21131 of the two bearing surfaces 2113 are defined as a second lateral edge pair. The tool bore 2120 penetrates the head body 2110 from the working side to the connecting side to form an opening on the tool bore surface 2111, and the tool bore 2120 is configured for receiving the cutting tool. The shaft 2200 is connected to the disposing surface 2112 of the head body 2110 and configured for inserting the base 1000. Two extending lines of the two lateral edges (lateral edges 1111 or lateral edges 21131) of at least one of the first lateral edge pair and the second lateral edge pair are close to each other.

Therefore, with that the two extending lines of the two lateral edges 1111 of the two positioning surfaces 1110 of the base 1000 and/or the two extending lines of the two lateral edges 21131 of the two bearing surfaces 2113 of the holder 2000 are close to each other, the effect that the base 1000 surrounds the holder 2000 as the holder 2000 inserting the base 1000 is increased, and the impact may be efficiently eliminated. Details of the cutting tool holding device 100 may be described hereinafter.

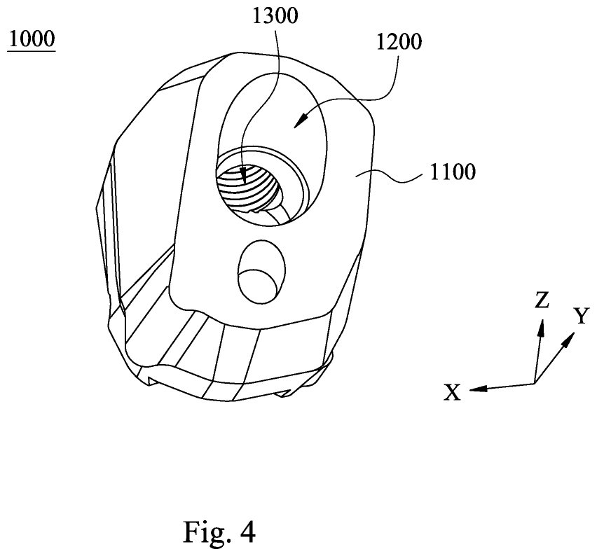

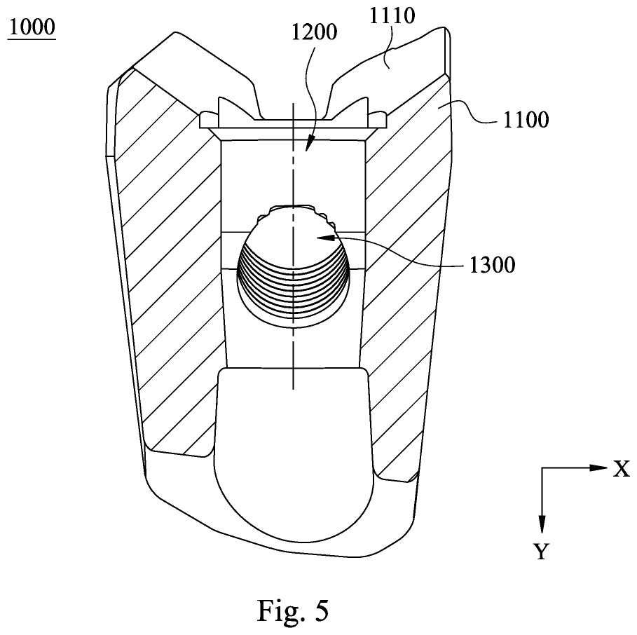

FIG. 4 shows another three-dimensional schematic view of the base 1000 of the embodiment of FIG. 1. FIG. 5 shows a cross-sectional view of the base 1000 of the embodiment of FIG. 2 taken along line 5-5. FIG. 6 shows a front view of the base 1000 of the embodiment of FIG. 1. The base 1000 is a three-dimensional chunk structure, which may be made by die forging. The inserted bore 1200 penetrates the base body 1100 along a Y-axis.

The positioning surfaces 1110 of the base body 1100 are inclined to each other, an external edge of each positioning surface 1110 is higher than an inserted opening 1210, and therefore the positioning space is formed. The two positioning surfaces 1110 may be respectively located at two sides of the inserted opening 1210. In the embodiment, the two extending lines of the two lateral edges 1111 of the first lateral edge pair are close to each other. In other words, the two extending lines of the two lateral edges 1111 are inclined upward and toward each other taken the Z-axis as the reference and form a pigeon-toed shape. Hence, as the two bearing surfaces 2113 are respectively abutted against the two positioning surfaces 1110, the holder 2000 may be fully surrounded to eliminate the impact, and vibration of the holder 2000 may be avoided. Moreover, the configuration of the pigeon-toed shape is favorable for preventing separation of the holder 2000 caused by the upward movement thereof as the cutting tool is milling the road. In addition, with the configuration of the pigeon-toed shape, the effects of center alignment and positioning may be enhanced.

The base body 1100 may further include two protrusions 1130 and a cavity 1140. Each of the protrusions 1130 is located below each of the positioning surfaces 1110, and the cavity 1140 is located below the inserted opening 1210 and the inserted bore 1200 and is between the two protrusions 1130. Precisely, each protrusion 1130 is located below each of the positioning surfaces 1110 taken a Z-axis as the reference, and because the two protrusions 1130 protrude farther away, the portion between the two protrusions 1130 may form the relative concave cavity 1140. The two protrusions 1130 and the cavity 1140 are configured for being associated with the holder 2000.

As shown in FIG. 3 and FIG. 6, the base 1000 may further include a bushing groove 1500 which is located at the base body 1100 and surrounds the inserted opening 1210 of the inserted bore 1200. Specifically, the shape of the bushing groove 1500 corresponds to the shape of a bushing (not shown). The bushing groove 1500 includes a circular portion 1510 and an engaging portion 1520, the circular portion 1510 surrounds the inserted opening 1210, and the engaging portion 1520 is communicated with the inserted opening 1210 and extends toward the Z-axis. It is noted that, only a part of the central connecting surface 1120 located above the engaging portion 1520 taken the Z-axis as the reference in the drawings may be seen owing to the bushing groove 1500, and the lateral edge 1111 indicates the junction between the positioning surface 1110 and the central connecting surface 1120 located above the engaging portion 1520. In other embodiment without the bushing groove, the inserted opening is formed on the central connecting surface, and the present disclosure is not limited thereto.

Moreover, during manufacturing the base body 1100, a thickness of the base body 1100 at a left side of the inserted bore 1200 is different from the thickness of the base body 1100 at a right side of the inserted bore 1200. In other words, as shown in FIGS. 5 and 6, the thickness of the base body 1100 at the left side is thicker than the thickness of the base body 1100 at the right side along an X-axis. Hence, it is favorable for pushing the cutting tool as the milling drum is rotated, thereby increasing the smoothness of the milling.

Furthermore, as shown in FIGS. 1 to 5, the base 1000 may further include a locking bore 1300 and a screwing member 1400. The locking bore 1300 penetrates the base body 1100 and is communicated with the inserted bore 1200. Consequently, after the holder 2000 is inserted into the inserted bore 1200, the screwing member 1400 may be fastened into the locking bore 1300 to abut against the holder 2000, thereby completing the fastening.

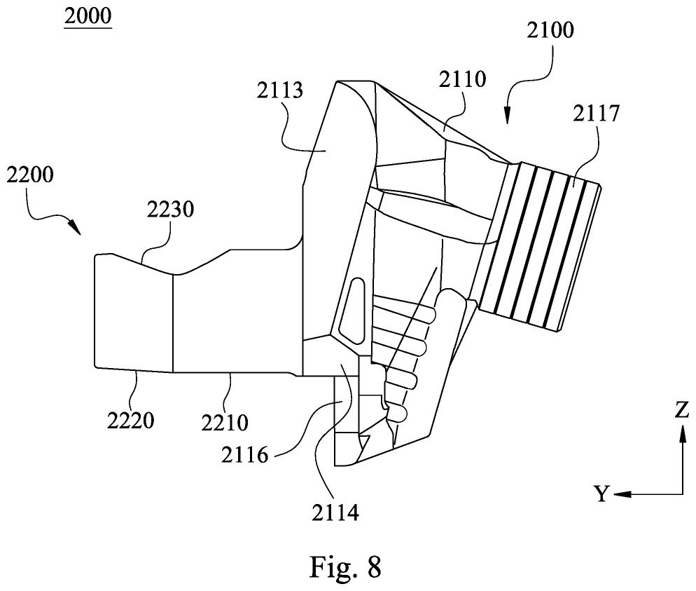

FIG. 7 shows a three-dimensional schematic view of a holder 2000 of the embodiment of the cutting tool holding device 100 of the embodiment of FIG. 1. FIG. 8 shows a side view of the holder 2000 of the embodiment of FIG. 1. The holder 2000 is a three-dimensional chunk structure, which may be made by die forging to form the disposing head 2100 and the shaft 2200 integrally. One side of the disposing head 2100 for installing the cutting tool may be defined as the working side, and another side of the disposing head 2100 for connecting the shaft 2200 and resting on the base 1000 may be defined as the connecting side. A barrel portion 2117 protrudes in the working side of the disposing head 2100, and the tool bore 2120 penetrates the barrel portion 2117. The head of the cutting tool may rest on the barrel portion 2117 as the cutting tool inserting the tool bore 2120. The shaft 2200 may include a tubular region 2210 integrally connected to the head body 2110 and a tapered region 2220 integrally connected to the tubular region 2210, and the tapered region 2220 tapers to an end away from the tubular region 2210. With the configuration that the shaft 2200 may include the tubular region 2210 and the tapered region 2220, and the tapered region 2220 tapers to the end away from the tubular region 2210, the engaging effect of the shaft 2200 inserting the base 1000 may be increased, and the load capability is also increased.

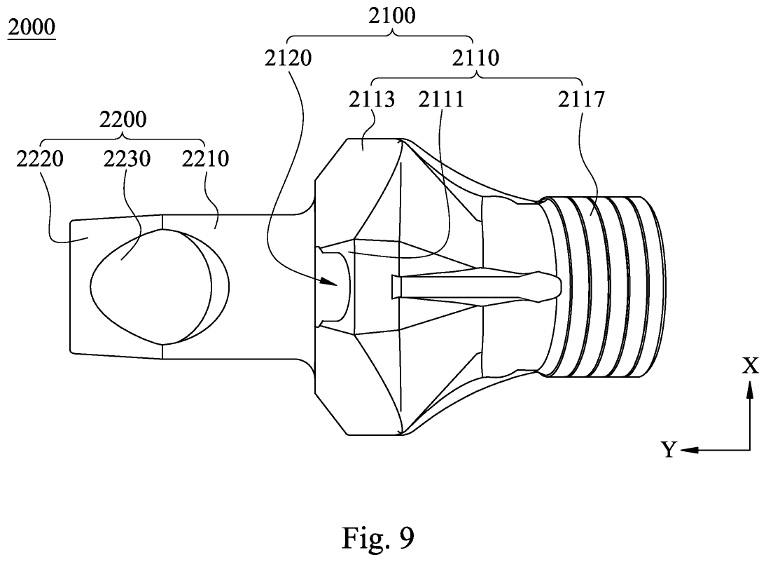

FIG. 9 shows a top view of the holder 2000 of the embodiment of FIG. 1. FIG. 10 shows a back view of the holder 2000 of the embodiment of FIG. 1. Please refer to FIGS. 9 and 10 with references of FIGS. 1, 2, 7 and 8. The shaft 2200 may extend along the Y-axis, and the tubular region 2210 of the shaft 2200 has a substantially uniform diameter except for a rounded edge of the portion connecting the head body 2110.

As shown in FIGS. 1, 2, 8 and 9, the tapered region 2220 is cone-shaped and includes a cone surface. As shown in FIG. 2, a vertical virtual symmetrical-surface passes the cone surface to form two tapered lines L1, L2, and an angle θ contained between the two tapered lines L1, L2 is in a range between 5 degrees to 10 degrees. In the embodiment, the angle θ is about 7 degrees. To be more specific, the vertical virtual symmetrical-surface can be deemed as the Y-axis and Z-axis plane, and passes the symmetrical central surface of the shaft 2200 on the X-axis. Hence, the cross-sectional view shown in FIG. 2 can be deemed as the cross-sectional view taken along the vertical virtual symmetrical-surface, and the upper boundary and the lower boundary of the tapered region 2220 shown in FIG. 3 may be deemed as the tapered lines L1, L2, respectively.

The shaft 2200 may further include a positioning notch 2230, one part of the positioning notch 2230 is located at the tubular region 2210, and another part of the positioning notch 2230 is located at the tapered region 2220. As shown in FIG. 1, the screwing member 1400 inserts the locking bore 1300 to abut against the positioning notch 2230. As shown in FIG. 2, the screwing member 1400 has a central axis C1, a cross point C11 is formed between the central axis C1 and an abutting surface 2232 of the positioning notch 2230. A virtual cross-surface S1 between the tubular region 2210 and the tapered region 2220 and an axis Y1 of the shaft 2200 are orthogonal, and the virtual cross-surface S1 passes the cross point C11. It is noted that, although the screwing member 1400 and the shaft 2200 are in a separated state in FIG. 2, the central axis C1 is also shown at the abutting surface 2232, thereby illustrating the cross point C11. Because the virtual cross-surface S1 is parallel to the X-axis and Z-axis plane, the virtual cross-surface S1 is illustrated by a line in FIG. 2.

Precisely, the positioning notch is 2230 has a V-shaped groove structure and includes a curved surface 2231 and the abutting surface 2232. The curved surface 2231 is located at the tubular region 2210, the abutting surface 2232 is a flat surface, one part of the abutting surface 2232 is located at the tubular region 2210, and another part of the abutting surface 2232 is located at the tapered region 2220. The axis Y1 is parallel to the Y-axis, and the virtual cross-surface S1 that passes the cross point C11 and is perpendicular to the Y-axis is parallel to the X-axis and Z-axis surface. In other words, as manufacturing the shaft 2200, the virtual cross-surface S1 may be deemed as a junction, the region between the virtual cross-surface S1 and the head body 2110 may, without considering the positioning notch 2230, have a uniform diameter, and other region may, without considering the positioning notch 2230, be tapered as a cone surface to form the tapered region 2220. In the embodiment, the shape of the inner wall of the inserted bore 1200 may be associated with the tubular region 2210 and the tapered region 2220 and a part of the inner wall of the inserted bore 1200 may be tapered. Therefore, vibration of the shaft 2200 as being inserted in the base 1000 may be avoided. Moreover, the shape of the shaft 2200 is also favorable for center alignment, which is favorable for the shaft 2200 to be automatically positioning as being inserted in the base 1000. Additionally, the tubular region 2210 is longer than the tapered region 2220 in the embodiment.

As shown in FIGS. 7, 9 and 10, the tool bore surface 2111 and the disposing surface 2212 are both flat surfaces, and the tool bore surface 2111 and the disposing surface 2212 are connected to form an angle. It is noted that, the terms of the tool bore surface 2111 and the disposing surface 2212 are used for illustration, and no real junction may be included between the tool bore surface 2111 and the disposing surface 2212. Moreover, a part of the tool bore 2120 may be located at the disposing surface 2112, that is, a part of the opening being located at the disposing surface 2112, but the present disclosure is not limited thereto. Furthermore, the disposing head 2100 may further include two cutting surfaces 2114 located at the connecting side, an upper edge of each of the cutting surfaces 2114 is connected to each of the bearing surfaces 2113, a side of each of the cutting surfaces 2114 is connected to the disposing surface 2112, and each of the cutting surfaces 2114 does not rest on the base 1000.

Precisely, the cutting surface 2114 may include two straight sides, the disposing surface 2112 may include two upper inclined sides and two lower inclined sides, and one end of each of the upper inclined sides is connected to each of the straight sides. The side edge 21132 and the lateral edge 21131 of one of the bearing surfaces 2113 and the side of each of the cutting surfaces 2114 may be respectively connected to the straight side, the upper inclined side and the lower inclined side at the left side, and the other one of the bearing surfaces 2113 and the other one of the cutting surfaces 2114 is respectively connected to the straight side, the upper inclined side and the lower inclined side at the right side. Therefore, the left side and the right side are symmetrically arranged. In the embodiment, the two extending lines of the two lateral edges 21131 of the second lateral edge pair are close to each other, but the present disclosure is not limited thereto.

The head body 2110 may further include two depressions 2115 and a projection 2116, each of the depressions 2115 is located below each of the bearing surfaces 2113 and corresponds to each of the protrusions 1130 of the base 1000, and the projection 2116 is located between the two depressions 2115 and corresponds to the cavity 1140 of the base 1000. As the holder 2000 is assembled with the base 1000, a gap is formed between each of the depressions 2115 of the head body 2110 and the protrusion 1130 of the base 1000 corresponding thereto. The cooperation of the projection 2116 and the cavity 1140 may have a positioning function, and thereby fabricating for preventing the shaft 2200 from being broken as being forced.

Hence, as installing the shaft 2200, the shaft 2200 may be inserted into the inserted bore 1200 first, then the two bearing surfaces 2113 may rest on the two positioning surfaces 1110, and finally the screwing member 1400 of the base 1000 may be fastened from the locking bore 1300 to abut against the positioning notch 2230, thereby assembling the holder 2000 on the base 1000. Additionally, as the cutting tool is working, the force will be transmitted from the holder 2000 to the base 1000, and because the structure of the cutting tool holding device 100 is enforced, the strength and the life time of the cutting tool holding device 100 are increased.

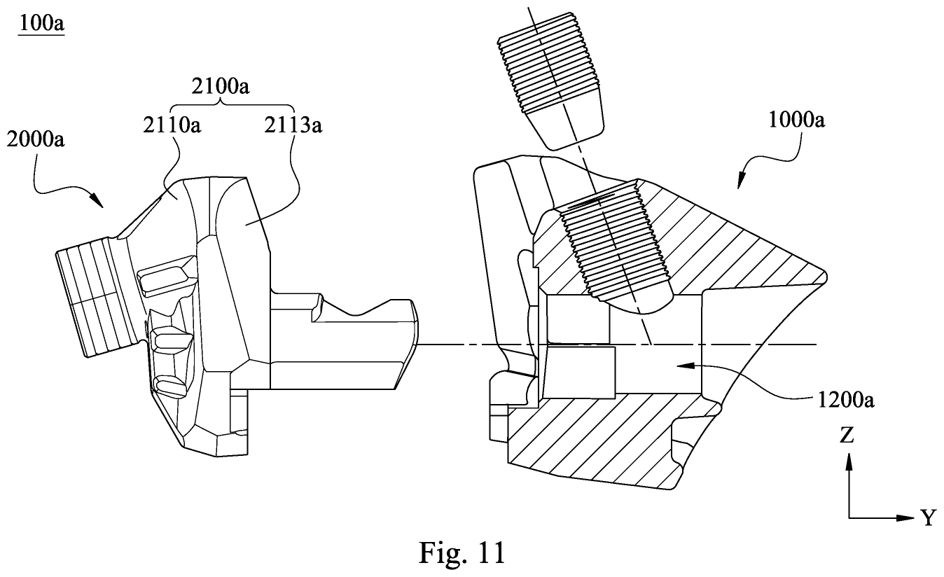

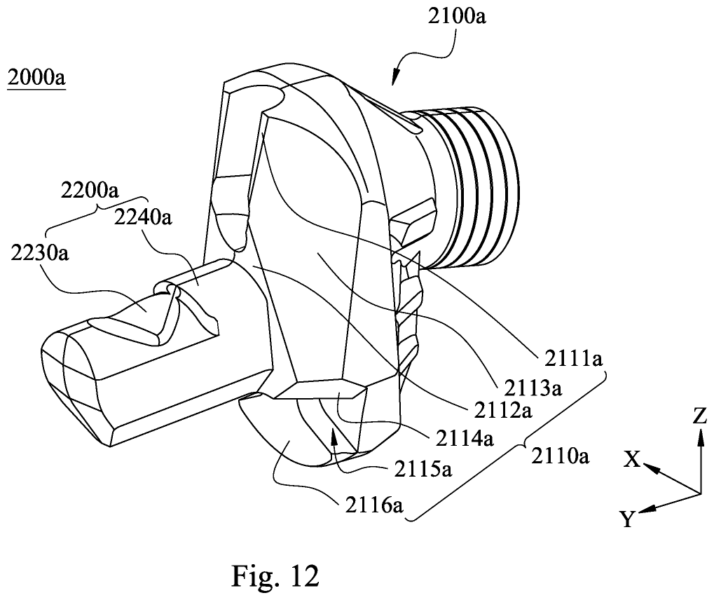

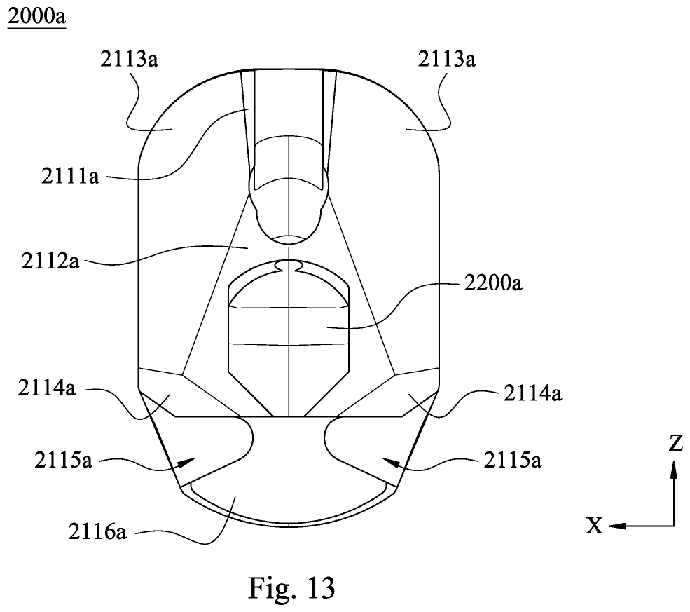

FIG. 11 shows a cross-sectional view of a cutting tool holding device 100a according to another embodiment of the present disclosure in a separated state. FIG. 12 shows a three-dimensional schematic view of a holder 2000a of the cutting tool holding device 100a of the embodiment in FIG. 11. FIG. 13 shows a back view of the holder 2000a of the embodiment of FIG. 11. The cutting tool holding device 100a includes a base 1000a and a holder 2000a, the structure of the base 1000a is similar to the base 1000 of FIGS. 1 to 6, and the details thereof will not be repeated.

The holder 2000a includes a disposing head 2100a and a shaft 2200a. The configuration of the 2100a is similar to the disposing head 2100 of FIGS. 7 to 10 and includes the head body 2110a, and the head body 2110a includes a tool bore surface 2111a, a disposing surface 2112a, two bearing surfaces 2113a, two cutting surfaces 2114a, two depressions 2115a and a projection 2116a located at the connecting side, but the structure of the shaft 2200a is different.

Specifically, the shaft 2200a does not include the tubular region 2210 and the tapered region 2220 as shown in FIGS. 7 to 10, but includes a prism-shaped region 2240a. The positioning notch 2230a is located at the prism-shaped region 2240a, and the inner wall of the inserted bore 1200a of the base 1000a may be associated with the shape of the prism-shaped region 2240a, but the present disclosure is not limited thereto.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A cutting tool holding device, which is applied for holding a cutting tool, the cutting tool holding device comprising:
a base, comprising:
a base body, comprising:
a central connecting surface; and
two positioning surfaces respectively located at two sides of the central connecting surface, the positioning surfaces being relatively inclined to define a positioning space, wherein a lateral edge of each of the positioning surfaces is connected to the central connecting surface, and the two lateral edges are defined as a first lateral edge pair; and
an inserted bore penetrating the base body; and
a holder inserting the inserted bore and configured for the cutting tool to insert thereinto, the holder comprising:
a disposing head, comprising:
a head body having a working side and a connecting side and comprising a tool bore surface, a disposing surface and two bearing surfaces located at the connecting side, wherein the tool bore surface is located above the disposing surface, two lateral edges of the two bearing surfaces are respectively connected to two sides of the disposing surface, the two bearing surfaces respectively correspond to the two positioning surfaces, two side edges of the two bearing surfaces are respectively connected to two sides of the tool bore surface, the lateral edge of each of the bearing surfaces is longer than the side edge of each of the bearing surfaces, and the two lateral edges of the two bearing surfaces are defined as a second lateral edge pair; and
a tool bore penetrating the head body from the working side to the connecting side to form an opening on the tool bore surface, the tool bore being configured for receiving the cutting tool; and
a shaft connected to the disposing surface of the head body and configured for inserting the base;
wherein two extending lines of the two lateral edges of at least one of the first lateral edge pair and the second lateral edge pair are close to each other.

2. The cutting tool holding device of claim 1, wherein the base body further comprises two protrusions and a cavity, each of the protrusions is located below each of the positioning surfaces, the cavity is located below the inserted bore and is between the two protrusions, the head body further comprises two depressions and a projection, each of the depressions is located below each of the bearing surfaces and corresponds to each of the protrusions, the projection is located between the two depressions and corresponds to the cavity, and as the holder is assembled with the base, a gap is formed between each of the depressions and the protrusion corresponding thereto.

3. The cutting tool holding device of claim 1, wherein a thickness of the base body at a left side of the inserted bore is different from the thickness of the base body at a right side of the inserted bore.

4. The cutting tool holding device of claim 1, wherein the shaft comprises:
a tubular region integrally connected to the head body; and
a tapered region integrally connected to the tubular region, the tapered region tapering to an end away from the tubular region.

5. The cutting tool holding device of claim 4, wherein the shaft further comprises a positioning notch, one part of the positioning notch is located at the tubular region, and another part of the positioning notch is located at the tapered region.

6. The cutting tool holding device of claim 5, wherein the base further comprises a locking bore, and the locking bore penetrates the base body and is communicated with the inserted bore.

7. The cutting tool holding device of claim 6, wherein the base further comprises a screwing member, the screwing member inserts the locking bore to abut against the positioning notch, the screwing member has a central axis, a cross point is formed between the central axis and an abutting surface of the positioning notch, a virtual cross-surface between the tubular region and the tapered region and an axis of the shaft are orthogonal, and the virtual cross-surface passes the cross point.

8. The cutting tool holding device of claim 4, wherein the tapered region comprises a cone surface.

9. The cutting tool holding device of claim 8, wherein a vertical virtual symmetrical-surface passes the cone surface to form two tapered lines, and an angle contained between the two tapered lines is in a range between 5 degrees to 10 degrees.

10. The cutting tool holding device of claim 1, wherein the disposing head further comprises two cutting surfaces located at the connecting side, an upper edge of each of the cutting surfaces is connected to each of the bearing surfaces, a side of each of the cutting surfaces is connected to the disposing surface, and each of the cutting surfaces does not rest on the base.
